(19) United States
(12) Patent Application Publication
(10) Pub. No.: US 2010/0070776 A1
(43) Pub. Date: Mar. 18, 2010

(54) Logging system events

(76) Inventors: Shankar RAMAN, Bangalore (IN); Kishore Kumar MUPPIRALA, Bangalore (IN); Sridhar BANDI, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/263,506

(22) Filed: Nov. 3, 2008

(30) Foreign Application Priority Data
Sep. 17, 2008 (IN) 2268/CHE/2008

(51) Int. Cl. G06F 21/24; G06F 12/14

(52) U.S. Cl. 713/189; 726/27; 711/103; 726/23; 711/E12.092

(57) ABSTRACT

Provided is computer implemented method for logging system events, comprising:
allocating a memory area for a log;
receiving data indicative of a log event;
storing said data in said memory area;
synchronising data in said memory area to a log file stored in non-volatile storage, the non-volatile storage and the memory area being inaccessible to a user or an administrator.

### RELATED APPLICATIONS

Benefit is claimed under 35 U.S.C. 119(a)-(d) to Foreign application Ser No. 2268/CHE/2008 entitled “LOGGING SYSTEM EVENTS” by Hewlett-Packard Development Company, L.P., filed on 17 Sep. 2008, which is herein incorporated in its entirety by reference for all purposes.

### BACKGROUND

There is an increasing trend for the outsourcing of information technology systems. As a result of this, the administration of information technology systems may additionally be outsourced. The administrator of an information technology system often has the ability to access and modify elements of an information technology system. In such systems, the maintenance of logs and audit trails of actions of an administrator allowed malicious activity by such an administrator to be detected. For example, host-based intrusion detection systems include a mechanism to report activity on a node to a centralized server through a network.

US Patent Application No. 2002/0046350 discloses a system and method for establishing a log file which may be used to create an audit trail.

A centralized server maintains a log file of actions performed by a requester and the security server which are related to protected objects.

Such systems however require that the network be connected. A malicious administrator could disable the network, and perform a malicious act, and remove any trace from system logs before connecting back to the network.

### BRIEF DESCRIPTION OF THE DRAWINGS

In the following, embodiments of the invention will be described, by way of example only, and with reference to the drawings in which:

FIG. 1 shows a block diagram of a data processing system,

FIG. 2 shows a flow diagram illustrating steps involved in a method of logging a system event,

FIG. 3 shows a flow diagram illustrating steps involved in a method of restoring a log of system events from a log file,

FIG. 4 is a flow diagram showing steps involved in a method of sending a log event to a server.

### DETAILED DESCRIPTION

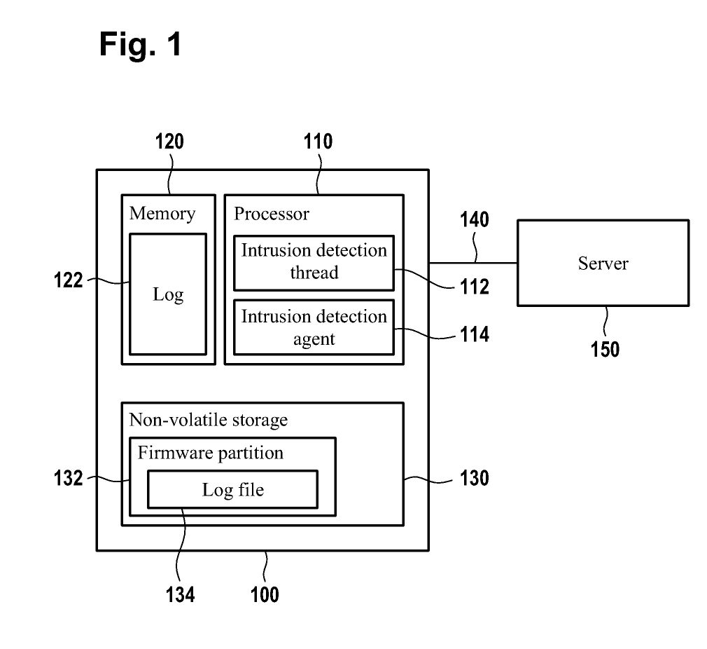

FIG. 1 shows data processing system 100. Data processing system 100 comprises processor 110, memory 120 and non-volatile storage 130. Data processing system 100 is connected to server 150 by network 140. Data processing system 100 may be a node of an IT system, and server 150 may be a centralized system which securely stores a log of activities received through network 140. The data processing system 100 may further comprise an intrusion detection thread 112 operable to allocate an area of the memory 120 for a log 122. The intrusion detection thread 112 may be operable to receive data indicative of a log event and to synchronize the log 122 with the log file 134.

Processor 110 executes intrusion detection thread 112 and intrusion detection agent 114. Intrusion detection agent 114 monitors the activities of an administrator or user on data processing system 100. Intrusion detection agent 114 sends data indicative of system events which are detected by intrusion detection agent 114 to intrusion detection thread 112. Intrusion detection thread 112 stores data indicative of system events in log 122 which is stored in memory 120. When activated, intrusion detection thread 112 allocates a portion of memory 120 for log 122. Intrusion detection agent 114 may mark log 122 as read only. This prevents other processes and applications from changing the data stored in log 122.

Intrusion detection agent 114 reads data from log 122 and sends the data indicative of the log event via network 140 to server 150. Intrusion detection thread 112 and intrusion detection agent 114 may be operating system components. Intrusion detection thread 112 may be a kernel thread, this thread may be implemented as an extension to an existing intrusion detection logging thread, or as an explicitly created kernel thread when the operating system is taken into a single user mode.

A kernel thread as understood herein is a fraction of a program running in the kernel process. A kernel thread exists within the context of a process and provides an operating system the means to address and execute smaller segments of the process. It also enables programs to take advantage of capabilities provided by the hardware for concurrent and parallel processing.

A single user mode allows the system to be booted for a single super user, forbidding other users to log into the system during a period of time. In general, this is a temporary mode where the system is taken into this mode for maintenance purposes.

Intrusion detection thread 112 synchronizes log 122 with a log file 134 stored in non-volatile storage 130. Non-volatile storage 130 may be for example a hard disc drive. Log file 134 is stored in a firmware partition 132 of non-volatile storage 130. Firmware partition 132 may be inaccessible to a user or administrator of data processing system 100. Firmware partition 132 may be implemented for example as an extensible firmware interface partition or other early boot firmware partition of non-volatile storage 130. Log file 134 may be stored in an encrypted format. This would provide a further security against a malicious user or administrator from modifying log file 134.

Intrusion detection thread 112 may synchronize log 122 to log file 134 periodically, after the reception of a certain number of events, or according to other criteria. When data processing system 100 is shut down, intrusion detection thread 112 synchronizes log 122 to log file 134 as part of the shutdown process. This ensures that all user activity is recorded in log file 134, and that a malicious user or administrator cannot avoid his or her activities from being detected and recorded by restarting or shutting down the system. Upon boot up of data processing system 100, intrusion detection thread may read log file 134 and record or write all events into log 122 stored in memory 120. The events are the contents of the log file 134.

As intrusion detection agent 114 log events to server 150 via network 140, they may be deleted from log 122 stored in memory 120 and log file 134 stored in non-volatile storage 130.

The kernel thread, running in the kernel process, may not be terminated by an administrator and detects all changes in the data processing system 100. The kernel thread logs the changes to a portion of the memory 120, securing audit records of changes from a malicious super user or administrator. The data processing system 100 may keep the log events communicated to a central server and logs the system activity events to a special region in the memory 120. It also synchronizes the logs in memory 120 to a log file 134 on the disk. The log file 134 is created in a disk area accessible by the firmware that can be read by the kernel thread. This avoids an administrator from corrupting the log file.

The data processing system 100 increases the accountability of the root administrator's activity in the single user mode. It also provides integrity of the audit records even when the system is not available in network mode, for example during system failures or reboots. When the data processing system 100 returns to an operational mode that enables the network connection between the data processing system 100 and the central console, the contents of the log file and in the log information in memory 120 is communicated back to the centralized console. All the activities of the data processing system 100 in a data center are logged and tracked, protecting it from security breaches.

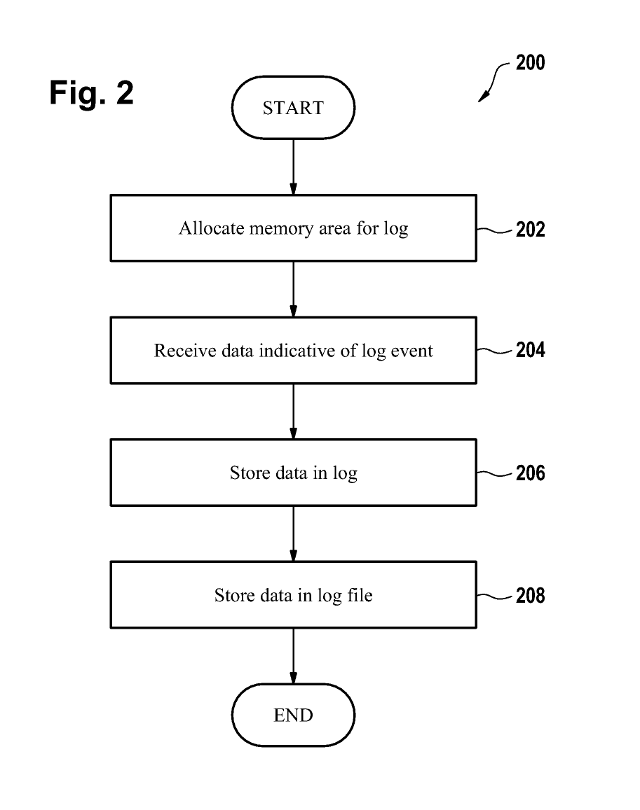

FIG. 2 shows a method 200 for logging system events. Method 200 may be carried out by an intrusion detection thread such as that shown as intrusion detection thread 122 in FIG. 1. In step 202 a memory area is allocated for the log. The area of memory allocated for the log in step 202 may be marked as read only. In step 204, data indicative of a log event is received. The data received may be from an intrusion detection agent such as intrusion detection agent 114 in FIG. 1. In step 206, the data received indicative of a log event is stored in the log. Following storage of the data in the log, memory location where the data is stored may be marked read only to prevent other applications or processes from filing or deleting the log data. In step 208, the data stored in the memory is synchronized to a log file stored in non-volatile storage. The log file in non-volatile storage may be inaccessible to a user or administrator of the system to prevent the user or administrator from changing the data. The method 200 is computer-implemented, such as by a client or a server computer.

As the kernel thread runs in the kernel process and the log 122 is stored in a read mode, the log file 134 is inaccessible to a user or administrator. In that way, a malicious administrator cannot alter or corrupt the log files and remove traces of malicious activity. Furthermore, as the log file 134 is stored in non-volatile storage 130, rebooting or restarting the system does not remove the data stored in the log file 134.

The method may further comprise the step of sending the data to a server via a network. This step may be carried out by an intrusion detection agent. The intrusion detection agent may also monitor the system and send the data indicative of a log event to the intrusion detection thread in step 204.

Method 200 may be triggered by detecting that a data processing system has been taken into a single user mode. Alternatively, method 200 may be triggered at boot up of a data processing system. Thus, the method may be executed when the data processing system 100 is taken into a single user mode, for example by disconnecting it from a network.

When the data is stored in the log file in step 208, the data may be encrypted. This provides a further protection of the data stored in the log file 134 from a malicious user or administrator.

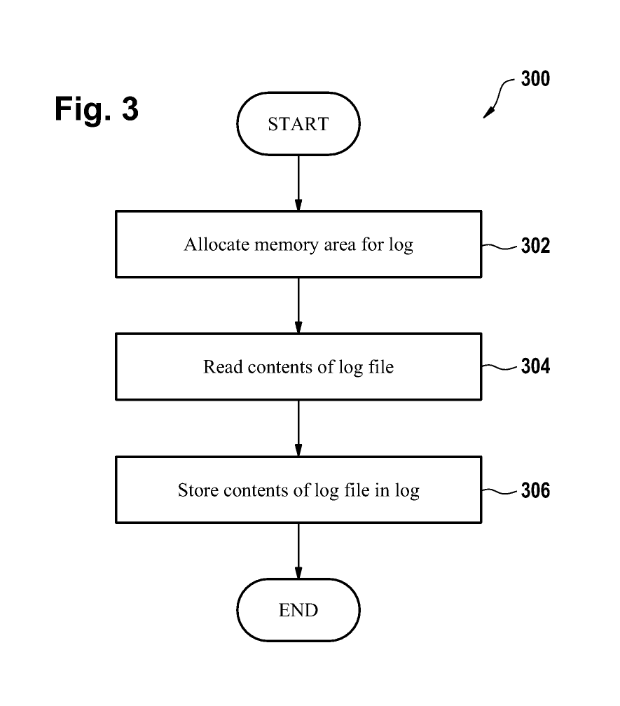

FIG. 3 shows a method 300 showing the steps undertaken upon boot up of a data processing system. In step 302, a memory area is allocated for the log. In step 304, the contents of the log files stored in non-volatile storage are read. In step 306, the contents read from the log file are stored in the log in the memory area. Thus, the log 122 may be restored from the non-volatile storage 130 to the memory 120 area.

The method may further comprise the step of marking the memory area as read only. In this way, other processes and applications are prevented from overwriting the memory. 120 The non-volatile storage 130 may be a partition accessible by early boot firmware.

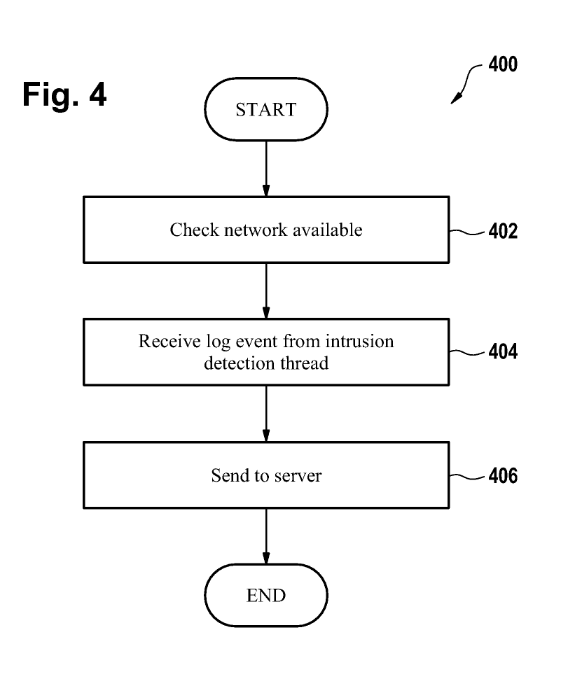

FIG. 4 shows a method 400 which may be undertaken by an intrusion detection agent such as intrusion detection agent 114 shown in FIG. 1. In step 402, the intrusion detection agent checks network availability. In step 404, the intrusion detection agent receives a log event from the intrusion detection thread. This may be in response to a request. The intrusion detection thread may supply the log events to the intrusion detection agent in a first in-first out order. Such an order would be the same order in which the events were received by the intrusion detection thread, which would be the order in which the events occurred. In step 406, the events are sent to the server.

The methods described above may be implemented as a hardware embodiment, a software embodiment, or a combination of the two. The methods may be implemented as a computer program product comprising computer readable instructions which when executed on a computer would cause the computer to execute the methods described above.

### LIST OF REFERENCE NUMERALS

100 data processing system

110 processor

112 intrusion detection thread

114 intrusion detection agent

120 memory

122 log

130 non-volatile storage

132 firmware partition

134 log file

140 network

150 server

200 method

202 allocate memory area for log

204 receive data indicative of log event

206 store data in log

208 store data in log file

300 method

302 allocate memory area for log

304 read contents of log file

306 store contents of log file in log

400 method

402 check network available

404 receive log event from intrusion detection thread

406 send to server

1. A computer implemented method in an intrusion detection thread for logging system events, comprising:
allocating a memory area for a log;
receiving data indicative of a log event;
storing said data in said memory area;
synchronising data in said memory area to a log file stored in non-volatile storage, the non-volatile storage and the memory area being inaccessible to a user or an administrator.

2. The method of claim 1, further comprising sending said data to a server via a network and detecting that a data processing system has been taken into a single user mode, wherein said intrusion detection thread is a kernel thread running in a kernel process.

3. The method of claim 1 or 2, further comprising encrypting the data stored in said log file and reading data from said log file upon boot up.

4. The method of any one of the preceding claims 1 to 3, further comprising marking said memory area read only, said non-volatile storage being a partition accessible by early boot firmware.

5. A data processing system comprising:
a memory;
a non-volatile storage, having a firmware partition, said firmware partition comprising storage for a log file;
an intrusion detection thread operable to allocate an area of said memory for a log, to receive data indicative of a log event and to synchronize said log to said log file.

6. The data processing system of claim 5, further comprising an intrusion detection agent operable to send said data indicative of said log event to said intrusion detection thread, wherein said intrusion detection thread is a kernel thread running in a kernel process.

7. The data processing system of claim 6, the intrusion detection agent further operable read said log and to send said data indicative of said log event to a server via a network.

8. The data processing system of any one of the preceding claims 5 to 7 said log file being encrypted, said intrusion detection thread being further operable to mark said area of said memory read only.

9. The data processing system of any one of the preceding claims 5 to 8 said intrusion thread triggered by said data processing system being taken into a single user mode.

10. The data processing system of any one of the preceding claims 5 to 9, said intrusion detection thread being further operable to read said log file upon boot up of said data processing system and to write the contents of said log file to said log.

11. The data processing system of any one of the preceding claims 5 to 10, said intrusion detection thread being further operable to synchronize said log to said log file in the event that said data processing system is shutdown.

12. A computer program product comprising computer executable instructions which when executed on an intrusion detection thread cause a computer to execute a method for logging system events, the method comprising:
allocating an area of a memory of said computer for logging system events;
receiving data indicative of a log event;
storing said data indicative of said log event in said area of said memory;
storing said data indicative of said log event on a partition of a non-volatile storage medium;

13. The computer program product of claim 12, the method further comprising marking said area of said memory read only, wherein said intrusion detection thread is a kernel thread running in a kernel process.

14. The computer program product of claims 12 or 13, the method further comprising reading data indicative of a previous log event from said non-volatile storage medium.

15. The computer program product of any one of claims 12 to 14, said partition of said non-volatile storage medium being an early boot firmware area, said early boot firmware area being inaccessible to a user of said computer, the method further comprising encrypting said data indicative of said log event.
